(19) United States
(12) Patent Application Publication
(10) Pub. No.: US 2015/0350166 A1
(43) Pub. Date: Dec. 3, 2015

(54) METHODS AND SYSTEMS OF COMMUNICATING ANONYMOUSLY FOR ENHANCED NETWORKING BY USING SPECIFIC LOCATIONS WITHIN A SPECIFIC RANGE OF DISTANCE

(71) Applicant: Shh App LLC, Morristown, NJ (US)

(72) Inventor: Christopher Hanson, Morristown, NJ (US)

(73) Assignee: Shh App LLC, Morristown, NJ (US)

(21) Appl. No.: 14/716,356

(22) Filed: May 19, 2015

Related U.S. Application Data
(60) Provisional application No. 62/004,601, filed on May 29, 2014.

(51) Int. Cl. H04L 29/06; H04L 29/12; G06F 17/30; H04W 4/02; H04L 12/58

(52) U.S. Cl. CPC H04L 63/0421; H04W 4/02; H04L 51/32; G06F 17/30979; H04L 61/609; H04L 65/403

(57) ABSTRACT

A method and system for robust social networking enabling a subscriber to anonymously communicate with other anonymous subscribers when the subscriber is located within a specific geographical area with other subscribers. The method and system also restrict the subscriber to only view the data transmitted by other subscribers if the subscriber is not located within the specific geographical area with these other subscribers. That is, if the subscriber is not located within the specific geographical area with other subscribers who transmit the data, the method and system will not permit the subscriber to post the subscriber's own messages in response to the data posted by other subscribers. However, the subscriber can rate the data posted by other subscribers even if the subscriber is outside the specific geographical area.

This application claims the benefit of U.S. Provisional Application No. 62/004,601, filed May 29, 2014, the disclosure of which is herein incorporated by reference.

### TECHNICAL FIELD

The present invention relates generally to social networking, and, more particularly, to providing a method and system for enabling a subscriber to anonymously communicate with other anonymous subscribers.

### BACKGROUND OF THE INVENTION

The growing popularity of social networking is changing the way in which people communicate and interact with one another on a daily basis. In fact, one social networking genre is directed to exchanging anonymous communications that allows users to conduct conversations and interactions without having to divulge personal information. A need exists for an enhanced social networking system that enables a user (or subscriber) to anonymously communicate with other anonymous users (or subscribers) when the subscriber is located within a specific geographical area with other subscribers.

### BRIEF SUMMARY OF THE EMBODIMENTS

The present disclosure relates to a method and system for robust social networking enabling a subscriber (i.e., user of an electronic communication device) to anonymously communicate (e.g., initiate and participate in data transmittal) with other anonymous subscribers when the subscriber is located within a specific geographical area with other subscribers. The disclosed method and system also restrict the subscriber to only view the data transmitted by other subscribers if the subscriber is not located within the specific geographical area with these other subscribers (i.e., “Look In” mode). That is, if the subscriber is not located within the specific geographical area with other subscribers who transmit the data, the disclosed method and system will not permit the subscriber to post own messages in response to the data posted by other subscribers. However, the subscriber can rate (“like” or “dislike”) the data posted by other subscribers even if the subscriber is outside the specific geographical area.

### BRIEF DESCRIPTION OF THE DRAWINGS

FIG. 1 illustrates a high-level diagram representing a method for communicating anonymously based on a specific geographic location;

FIG. 2 illustrates a high-level block diagram of a system for communicating anonymously based on a specific geographic location;

FIG. 3 illustrates an exemplary electronic communication device used, illustratively, by subscribers to connect to the system of FIG. 2; and

FIG. 4 is a high-level block diagram of a system which can be implemented as the system shown in FIG. 2.

### DETAILED DESCRIPTION

The present disclosure relates to a method and system for robust social networking enabling a subscriber (i.e., user of an electronic communication device) to anonymously communicate (e.g., initiate and participate in data transmittal) with other anonymous subscribers when the subscriber is located within a specific geographical area with other subscribers. The disclosed method and system also restrict the subscriber to only view the data transmitted by other subscribers if the subscriber is not located within the specific geographical area with these other subscribers (i.e., “Look In” mode). That is, if the subscriber is not located within the specific geographical area with other subscribers who transmit the data, the disclosed method and system will not permit the subscriber to post own messages in response to the data posted by other subscribers. However, the subscriber can rate (“like” or “dislike”) the data posted by other subscribers even if the subscriber is outside the specific geographical area.

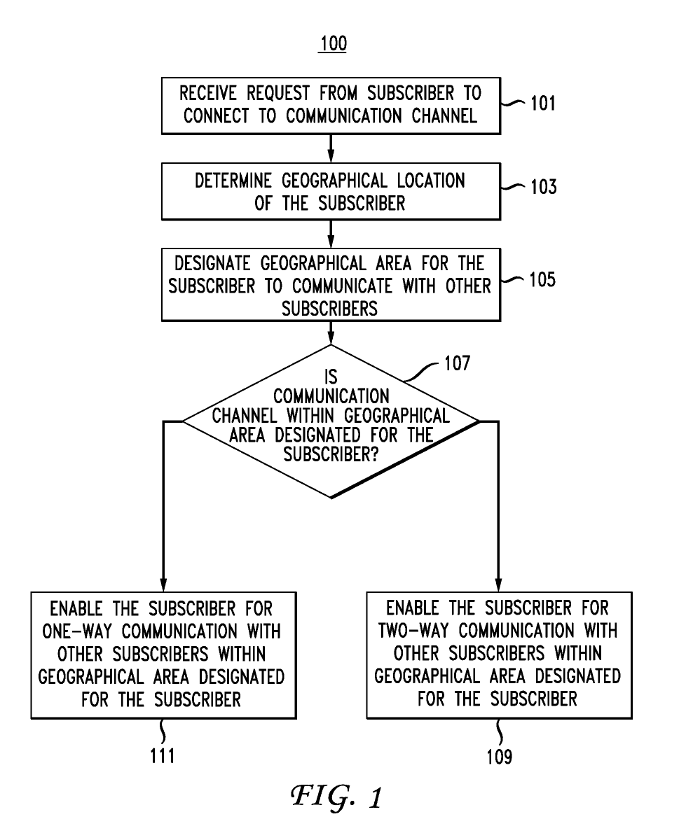

FIG. 1 illustrates a high-level diagram representing a method 100 for communicating anonymously based on a specific geographic location. At step 101, a request to connect to at least one of a plurality of communication channels is received by the system from a subscriber. The term “communication channel”, with respect to the disclosed system and method, means a communication thread initiated by the subscribers in relation to a particular topic, theme, event, point of interest, or the like, identified and searchable by a title. It is to be understood that the request to connect can be initiated in a number of ways, such as 1) activating a “connect” button (or its equivalent) within a mobile application stored and running on a portable electronic device (e.g., smartphone, notebook computer, tablet, personal data assistant (PDA), and the like), 2) activating a “connect” button on a website page through which the subscriber is connected to the system via an electronic device (e.g., desktop computer, laptop computer, and the like), 3) issuing a voice command via a voice-recognition utility of the system, 4) initiating a gesture in a close proximity of the portable electronic device capable of recognizing and interpreting haptic commands. It is also to be understood that the request to connect to one of the plurality of communication channels can be preceded by a search of a geographic area in which the subscriber is located to identify a plurality of communication channels to which the subscriber may want to connect.

Returning to FIG. 1, at step 103, the subscriber's geographic location, based on a geographic location of an electronic communication device, is determined. Methods of determining geographic location of electronic devices are known in the art and thus are not explicitly described herein.

At step 105, following the determination of a geographical location of the subscriber, a geographical area in which the subscriber is located is designated for the subscriber, where the designated geographical area is limited by a predetermined radius. The predetermined radius signifies a limit beyond which the subscriber is restricted to participate in the subscribed communication channel only as an observer, i.e., the “Look In” mode. It is to be understood that the designated geographical area can be measured in any unit of measurement, e.g., feet, yards, and miles. Also, the designated geographical area can have a default value and a custom value, where the default value is set by the system and the custom value can be requested by the subscriber. The request for the custom designated geographical area can be granted free of charge or for a fee.

At step 107, a determination is made whether a communication channel to which the subscriber requests connection is within the designated geographical area for the requesting subscriber. If the determination is made that the communication channel to which the subscriber requests connection is within the designated geographical area for the requesting subscriber, at step 109, the subscriber is enabled by the system to participate in the communication channel by receiving data content being posted by other subscribers and by posting the subscriber's own message in response to the received data content. The subscriber also can rate (favorably or otherwise) the received data content and/or initiate a new topic. There is no pre-set limit to the number of subscribers who can participate within any given communication channel.

If the determination is made that the communication channel to which the subscriber requests connection is outside the designated geographical area for the requesting subscriber, at step 111, the subscriber is restricted by the system to be an observer only. In other words, at step 111, the subscriber is connected to the requested communication channel but is restricted to only view the posted data content without being able to post own data. The subscriber can, however, be permitted to rate the data posted by other subscribers.

If the subscriber initiates a communication channel, said communication channel remains in the geographical location where it was initiated even if the subscriber who initiated the communication channel is no longer present in this geographical location. In other words, if the subscriber initiates a communication channel and exits the designated geographical area, the communication channel remains in the designated geographical location while the subscriber is restricted to be an observer of the content data posted by other subscribers who remain in the designated geographical area where the communication channel was initiated by the subscriber. As noted above, the subscriber can be permitted to rate the data posted by other subscribers even if the subscriber is located outside the designated geographical area.

One example of using the disclosed method and system is a restaurant's patron participation in a discussion of possible choices on a menu in a restaurant where the patron, by using his smartphone, identifies other subscribers of the system who are present in the same restaurant (i.e., within the predetermined geographical area). The subscriber may select one of the topics currently being discussed (e.g., “signature lobster bisque”) by these subscribers. Due to satisfying the system's geographic proximity requirement, the subscriber may read and respond to messages (text, pictures, links, and the like) posted by other patrons-subscribers with respect to the selected topic. The subscriber may also rate (e.g., “like” or “dislike”) the posts of other subscribers. If the restaurant is a part of a restaurant chain which includes other restaurants located in other cities, states, or countries, the subscriber may search the geographical area in which these other restaurants are located to see if patrons in those restaurants made any postings about the same/related topic. If other restaurants in the chain are located outside of the predetermined geographical area from the subscriber, the subscriber will only be permitted to view the postings without being able to either make own postings or being able to rate the postings of other subscribers. If the subscriber initiates a new topic in the restaurant (e.g., “House Merlot”) and eventually leaves the restaurant, the topic, if discussed by other patrons in the restaurant, remains “local” to the area of the restaurant. However, the patron who initiated the topic, while being able to view and rate the data posted by other subscribers-patrons of the restaurant, is no longer permitted to post data for the “House Merlot” topic.

Other example of using the disclosed method and system is searching the system for communication channels (discussion threads) based on a topic of interest or based on a certain geographic location. For example, in anticipation of the upcoming Soccer World Cup in Brazil, a subscriber, an avid follower of the U.S. National Soccer Team, wants to know about the progress of completion of the stadium where his favorite team is scheduled to play in a month. The subscriber searches the system for a geographical location of the town in Brazil where the U.S. Soccer Team will be situated and requests a connection to the communication channel based on the located subscribers in the identified geographical area. Because the identified geographical area is outside the designated geographic area in which the subscriber is located, the subscriber is restricted to only observe or to rate (e.g., “like” or “dislike”) the posts generated by the subscribers in the identified geographical area (i.e., town in Brazil).

The described system can be configured in such a way that all messages and posts within any given communication channel are deleted within a specified time (for example, within 24 hours).

The described system and method can be built and utilized using existing databases or by creating new dedicated databases. Similarly, the described system can use the existing service providers to subscribe to location-determining services (e.g., GPS, GLONASS, etc.)

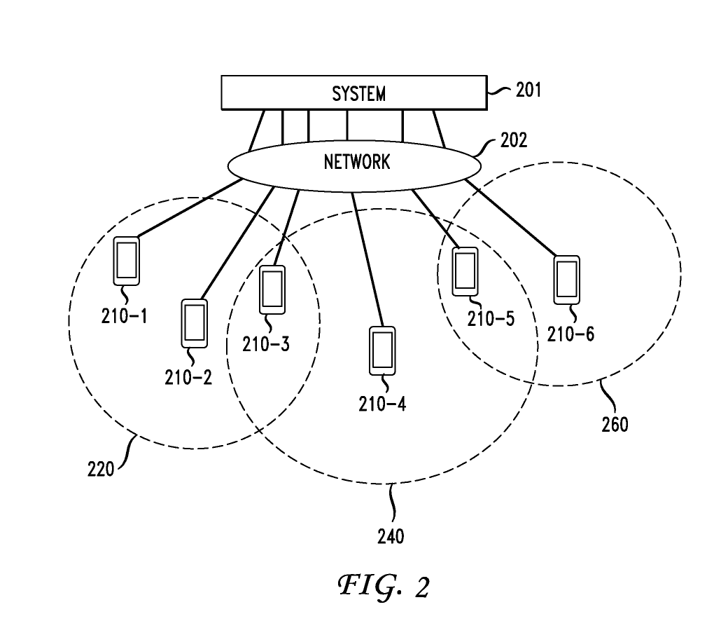

FIG. 2 illustrates a high-level block diagram of a system for communicating anonymously based on a specific geographic location. FIG. 2 shows a described system 201 to which subscribers 210-1, 210-2, 210-3, 210-4, 210-5; and 210-6 are connected, via network 202, using a proprietary and/or generally known connection protocols. The subscribers 210-1, 210-2, 210-3, 210-4, 210-5, and 210-6 in FIG. 2 are identified as electronic communication devices through which subscribers 210-1, 210-2, 210-3, 210-4, 210-5, and 210-6 connect to the system 201. FIG. 2 also illustrates a predetermined geographical area assigned to subscribers. For illustration purposes the predetermined geographical area of only some of the subscribers (210-2, 210-4, and 210-6) is shown in FIG. 2. Specifically, subscriber 210-2 is shown to be associated with the predetermined geographical area 220, subscriber 210-4 is shown to be associated with the predetermined geographical area 240, and subscriber 210-6 is shown to be associated with the predetermined geographical area 260. In the example of FIG. 2, subscriber 210-2 is located within a predetermined geographical area 220 with at least two other subscribers—210-1 and 210-3. It means that subscriber 210-2 can join communication channels initiated by subscribers 210-1 and 210-3 by viewing, rating, or responding to data postings by subscribers 210-1 and 210-3. Also, if subscriber 210-2 opens a new communication channel by selecting a new topic, subscribers 210-1 and 210-3 can also communicate with subscriber 210-2 by viewing, rating, or responding to data postings by subscriber 210-2. While subscriber 210-2 is permitted to join communication channels of subscribers 210-1 and 210-3, subscriber 210-2 is permitted to view and to rate data posted by subscribers 210-4, 210-5, and 210-6 without being able to respond to the data posted by subscribers 210-4, 210-5, and 210-6 because subscribers 210-4, 210-5, and 210-6 are shown to be outside the predetermined geographical area 220 with which subscriber 210-2 is associated.

FIG. 2 also shows subscriber 210-4 being associated with pre-determined geographical area 240. Subscriber 210-4 is shown to be in pre-determined area 240 with at least two other subscribers—210-3 and 210-5. It means that subscriber 210-4 can join communication channels initiated by subscribers 210-3 and 210-5 by viewing, rating, or responding to data postings by subscribers 210-3 and 210-5. Also, if subscriber 210-4 opens a new communication channel by selecting a new topic, subscribers 210-3 and 210-5 can also communicate with subscriber 210-4 by viewing, rating, or responding to data postings by subscriber 210-4. While subscriber 210-4 is permitted to join communication channels of subscribers 210-3 and 210-5, subscriber 210-4 is permitted to view and to rate data posted by subscribers 210-1, 210-2, and 210-6 without being able to post own data in response to the data posted by subscribers 210-1, 210-2, and 210-6 because subscribers 210A, 210-2, and 210-6 are shown to be outside the predetermined geographical area 240 with which subscriber 210-4 is associated.

FIG. 2 also shows subscriber 210-6 being associated with pre-determined geographic area 260. Subscriber 210-6 is shown to be in pre-determined geographic area 260 with at least one other subscriber—210-5. It means that subscriber 210-6 can join communication channels initiated by subscriber 210-5 by viewing, rating, or responding to data postings by subscriber 210-5. Also, if subscriber 210-6 opens a new communication channel by selecting a new topic, subscriber 210-5 can also communicate with subscriber 210-6 by viewing, rating, or responding to data postings by subscriber 210-6. While subscriber 210-6 is permitted to join communication channels of subscriber 210-5, subscriber 210-6 is permitted to view and to rate data posted by subscribers 210-1, 210-2, 210-3, and 210-4 without being able to post own data in response to the data posted by subscribers 210-1, 210-2, 210-3, and 210-4 because subscribers 210-1, 210-2, 210-3, and 210-4 are shown to be outside the predetermined geographical area 260 with which subscriber 210-6 is associated.

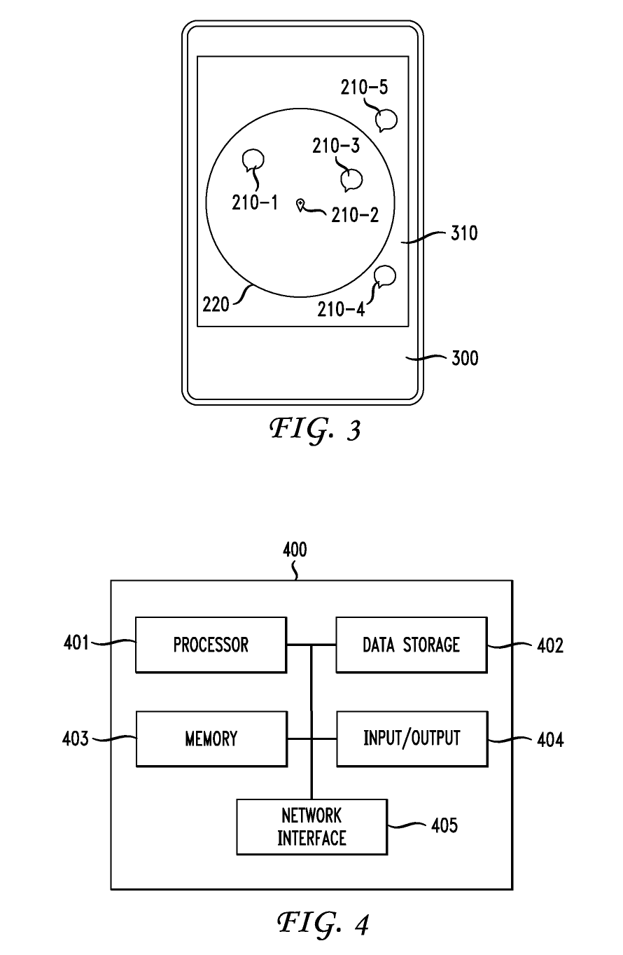

FIG. 3 illustrates an exemplary electronic communication device 300 used to connect to system 201 by subscriber 210-2 of FIG. 2. Specifically, FIG. 3 illustrates electronic communication device 300 having a screen 310 which displays predetermined geographical area 220 radiating from a geographical location of subscriber 210-2. In correspondence with FIG. 2, screen 310 also displays locations of subscribers 210-1 and 210-3 by means of displaying communication channels 210-1 and 210-3 (i.e. displayed as a conversation “bubbles”) initiated subscribers 210-1 and 210-3, respectively. Showing both subscribers 210-1 and 210-3 within the boundaries of predetermined geographical area 220 indicates to subscriber 210-2 that subscriber 210-2 can communicate with subscribers 210-1 and 210-3 by viewing, rating, and responding to data posted by subscribers 210-1 and 210-3. Screen 310 also displays locations of subscribers 210-4 and 210-5 by means of displaying communication channels 210-4 and 210-5 (i.e. displayed as a conversation “bubbles”) initiated by subscribers 210-4 and 210-5, respectively. Since each of subscribers 210-4 and 210-5 are shown to be outside predetermined geographical area 220, subscriber 210-2 is implicitly informed by the system 201 that subscriber 210-2 is allowed to view and to rate data posted by subscribers 210-4 and 210-5 but he or she is not allowed to post own data in response to data posted by subscribers 210-4 and 210-5. It is to be understood that, although subscriber 210-6 is not shown on screen 310, subscriber 210-2 can locate subscriber 210-6 by either zooming out the view of screen 310 to cover larger geographical area or to search a geographical area in which subscriber 210-6 is located.

FIG. 4 is a high-level block diagram of a system 400 which can be implemented as a system 201 of FIG. 2. System 400 comprises a processor 401 operatively coupled to a data storage device 402 and a memory 403. Processor 401 controls the overall operation of computer 400 by executing computer program instructions that define such operations. The computer program instructions may be stored in data storage device 402, or other computer readable medium, and loaded into memory 403 when execution of the computer program instructions is desired. Thus, the steps of method 100 in FIG. 1 can be defined by the computer program instructions stored in memory 403 and/or data storage device 402 and controlled by processor 401 executing the computer program instructions. For example, the computer program instructions can be implemented as computer executable code programmed by one skilled in the art to perform an algorithm defined by the method steps of FIG. 1. Accordingly, by executing the computer program instructions, the processor 401 executes an algorithm defined by the method steps of FIG. 1. Computer 400 also includes one or more network interfaces 405 for communicating with other devices via a network. Computer 400 also includes one or more input/output devices 404 that enable user interaction with computer 400 (e.g., display, keyboard, mouse, speakers, buttons, etc.).

Processor 401 may include both general and special purpose microprocessors, and may be the sole processor or one of multiple processors of computer 400. Processor 401 may comprise one or more central processing units (CPUs), for example. Processor 401, data storage device 402, and/or memory 403 may include, be supplemented by, or incorporated in, one or more application-specific integrated circuits (ASICs) and/or one or more field programmable gate arrays (FPGAs).

Data storage device 402 and memory 403 each comprise a tangible non-transitory computer readable storage medium. Data storage device 402, and memory 403, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 404 may include peripherals, such as a printer, scanner, display screen, etc. For example, input/output devices 404 may include a display device such as a cathode ray tube (CRT), plasma or liquid crystal display (LCD) monitor for displaying information to the user, a keyboard, and a pointing device such as a mouse or a trackball by which the user can provide input to computer 400.

It should be noted that for clarity of explanation, the illustrative embodiments described herein may be presented as comprising individual functional blocks or combinations of functional blocks. The functions these blocks represent may be provided through the use of either dedicated or shared hardware, including, but not limited to, hardware capable of executing software. Illustrative embodiments may comprise digital signal processor (“DSP”) hardware and/or software performing the operation described herein. Thus, for example, it will be appreciated by those skilled in the art that the block diagrams herein represent conceptual views of illustrative functions, operations and/or circuitry of the principles described in the various embodiments herein. Similarly, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for exchanging anonymous communications across a plurality of communication channels of a social network, the method comprising:
determining a current geographical location of a particular one subscriber of a plurality of subscribers;
designating a geographical area for the particular one subscriber of the plurality of subscribers based on the current geographical location of the particular one subscriber;
prohibiting the particular one subscriber from participating in at least one communication channel of the plurality of communication channels while the at least one communication channel is determined to be outside the designated geographical area for the particular one subscriber; and
enabling an observation of the at least one communication channel by the particular one subscriber.

2. The method of claim 1 further comprising:
enabling the particular one subscriber to participate in the at least one communication channel of the plurality of communication channels while the at least one communication channel is determined to be within the designated geographical area for the particular one subscriber.

3. The method of claim 1 wherein the enabling the observation of the at least one communication channel by the particular one subscriber further comprises:
viewing, by the particular one subscriber, content posted by at least one other subscriber of the plurality of subscribers.

4. The method of claim 3 wherein the enabling the observation of the at least one communication channel by the particular one subscriber further comprises:
rating, by the particular one subscriber, the viewed content posted by the at least one other subscriber of the plurality of subscribers.

5. The method of claim 2 further comprising:
searching, by the particular one subscriber, for an identified geographical location; and
requesting to join a particular one communication channel of the plurality of communication channels associated with the identified geographical location.

6. The method of claim 2 further comprising:
searching, by the particular one subscriber, for a particular one communication channel of the plurality of communication channels; and
requesting to join the particular one communication channel.

7. The method of claim 2 further comprising:
initiating, by the particular one subscriber, at least one communication channel when the particular one subscriber is within the designated geographical area.

8. The method of claim 1 wherein the area of the designated geographical area is a custom value requested by the particular one subscriber.

9. The method of claim 1 wherein the current geographical location of the particular one subscriber is determined from a location of an electronic communication device associated with the particular one subscriber.

10. The method of claim 8 wherein the custom value is less than five miles.

11. The method of claim 1 wherein the at least one communication channel is a communication thread initiated by a particular one other subscriber of the plurality of subscribers in relation to a particular topic.

12. The method of claim 2 further comprising:
identifying one or more other subscribers of the plurality of subscribers currently within the designated geographical area.

13. The method of claim 1 further comprising:
requesting, by the particular one subscriber of the plurality of subscribers, a connection to the at least one communication channel of the plurality of communications channels.

14. The method of claim 2 wherein the enabling the particular one subscriber to participate in the at least one communication channel further comprises:
receiving data content posted by at least one other subscriber of the plurality of subscribers on the at least one communication channel.

15. The method of claim 14 wherein the enabling the particular one subscriber to participate in the at least one communication channel further comprises:
posting a message, by the particular one subscriber, in response to the receiving the data content posted by the at least one other subscriber of the plurality of subscribers.

16. A system for providing a social network having a plurality of subscribers exchanging anonymous communications across a plurality of communication channels, the system comprising:
one or more computing devices; and
one or more non-transitory computer-readable mediums storing computer program instructions coupled to respective ones of the one or more computing devices for the exchanging anonymous communications across the plurality of communication channels, the computer program instructions, when executed on the one or more computing devices, cause the one or more computing devices to perform operations comprising:
assigning a plurality of predetermined geographical areas to the plurality of subscribers, at least one predetermined geographical area being assigned to each one subscriber of the plurality of subscribers;
enabling, when a particular one subscriber and a first one other subscriber are within a same one predetermined geographical area of the predetermined geographical areas, the particular one subscriber to join and exchange unrestricted communications over a first communication channel of the plurality of communication channels, the first communication channel being initiated by the first one other subscriber; and
enabling, when the particular one subscriber and a second one other subscriber are in different respective predetermined geographical areas of the predetermined geographical areas, the particular one subscriber to join and exchange restricted communications over a second communication channel of the plurality of communication channels, the second communication channel being initiated by the second one other subscriber.

17. The system of claim 16 wherein the exchange of restricted communications over the second communication channel is restricted to viewing and rating data posted on the second communication channel.

18. The system of claim 16 wherein the exchange of unrestricted communications over the first communication channel includes responding to data posted on the first communication channel.

19. The system of claim 16 wherein the one or more computing devices include one or more electronic communication devices associated with respective ones of the plurality of subscribers.

20. The system of claim 16 wherein the one or more computing devices include one or more servers.

21. The system of claim 19 wherein the respective ones of the plurality of subscribers are connected to the system via a network.

22. A system for providing a social network comprising:
means for determining a current geographical location of a particular one subscriber of a plurality of subscribers;
means for designating a geographical area for the particular one subscriber of the plurality of subscribers based on the current geographical location of the particular one subscriber;
means for prohibiting the particular one subscriber from participating in at least one communication channel of a plurality of communication channels while the at least one communication channel is determined to be outside the designated geographical area for the particular one subscriber; and
means for enabling an observation of the at least one communication channel by the particular one subscriber.

23. The system of claim 22 wherein the system further comprises:
means for enabling the particular one subscriber to participate in the at least one communication channel of the plurality of communication channels while the at least one communication channel is determined to be within the designated geographical area for the particular one subscriber.

24. The system of claim 22 wherein the current geographical location of the particular one subscriber is determined from an electronic communication device associated with the particular one subscriber.

25. A non-transitory computer-readable medium storing computer program instructions for providing anonymous communications across a social network, the computer program instructions, when executed on a processor, cause the processor to perform operations comprising:
determining a current geographical location of a particular one subscriber of a plurality of subscribers;
designating a geographical area for the particular one subscriber of the plurality of subscribers based on the current geographical location of the particular one subscriber;
prohibiting the particular one subscriber from participating in at least one communication channel of a plurality of communication channels while the at least one communication channel is determined to be outside the designated geographical area for the particular one subscriber; and
enabling an observation of the at least one communication channel by the particular one subscriber.

26. The non-transitory computer-readable medium of claim 25 wherein the operations further comprise:
enabling the particular one subscriber to participate in the at least one communication channel of the plurality of communication channels while the at least one communication channel is determined to be within the designated geographical area for the particular one subscriber.

27. The non-transitory computer-readable medium of claim 25 wherein the operations further comprise:
viewing, by the particular one subscriber, content posted by at least one other subscriber of the plurality of subscribers.

28. The non-transitory computer-readable medium of claim 27 wherein the operations further comprise:
rating, by the particular one subscriber, the viewed content posted by the at least one other subscriber of the plurality of subscribers.

29. The non-transitory computer-readable medium of claim 26 wherein the operations further comprise:
receiving data content posted by at least one other subscriber of the plurality of subscribers on the at least one communication channel; and
posting a message, by the particular one subscriber, in response to the receiving data content posted by the at least one other subscriber of the plurality of subscribers.

30. An electronic communication device comprising:
a display for displaying (i) at least one predetermined geographical area radiating from a geographical location of at least one subscriber of a plurality of subscribers to a social network; (ii) one or more communication channels within the at least one predetermined geographical area; and (iii) one or more communication channels outside the at least one predetermined geographical area; and
a processor for establishing a connection between the electronic communication device and the social network, wherein the connection provides for (i) the at least one subscriber to join and exchange unrestricted communications over the one or more communication channels within the at least one predetermined geographical area, and (ii) the at least one subscriber to join and exchange restricted communications over the one or more communication channels outside the at least one predetermined geographical area.

31. The electronic communication device of claim 30 wherein the unrestricted communications include receiving data content posted by at least one other subscriber of the plurality of subscribers.

32. The electronic communication device of claim 30 wherein the restricted communications include viewing content posted by at least one other subscriber of the plurality of subscribers.

33. The electronic communication device of claim 30 wherein the electronic communication device is a smartphone.

34. The electronic communication device of claim 30 wherein the display includes a zoom for use by the at least one subscriber to locate at least one other subscriber of the plurality of subscribers.

35. A method for exchanging anonymous communications across a plurality of communication channels of a social network, the method comprising:
receiving a request from a particular one subscriber of a plurality of subscribers to connect to a particular one communication channel of the plurality of communication channels;
determining a geographical location of the particular one subscriber of the plurality of subscribers;
designating a geographical area for the particular one subscriber to communicate with particular other subscribers of the plurality of subscribers;
determining whether the particular one communication channel is within the designated geographical area;
enabling one-way communication between the particular one subscriber and the particular other subscribers if the particular one communication channel is determined to be outside the designated geographical area; and
enabling two-way communication between the particular one subscriber and the particular other subscribers if the particular one communication channel is determined to be within the designated geographical area.

36. The method of claim 35 wherein the enabling the one-way communication further comprises:
viewing posted data content on the particular one communication channel.

37. The method of claim 36 wherein the enabling the one-way communication further comprises:
rating the viewed posted data content on the particular one communication channel.

38. The method of claim 35 wherein the two-way communication includes:
receiving data content, by the particular one subscriber, posted on the particular one communication channel by at least one of the particular other subscribers of the plurality of subscribers; and
posting a message, by the particular one subscriber, in response to the received data content.

39. The method of claim 35 further comprising:
searching, by the particular one subscriber, for an identified geographical location; and
requesting to join a particular one communication channel of the plurality of communication channels associated with the identified geographical location.

40. The method of claim 35 further comprising:
searching, by the particular one subscriber, for the particular one communication channel of the plurality of communication channels; and
requesting to join the particular one communication channel.

41. The method of claim 35 further comprising:
initiating, by the particular one subscriber, at least one communication channel when the particular one subscriber is within the designated geographical area.

42. The method of claim 35 wherein the designated geographical area is a custom value requested by the particular one subscriber.

43. The method of claim 35 wherein the geographical location of the particular one subscriber is determined from a location of an electronic communication device associated with the particular one subscriber.

44. The method of claim 42 wherein the custom value is less than one mile.

45. The method of claim 43 wherein the electronic communication device is a tablet.
